(19) United States
(12) Patent Application Publication
(10) Pub. No.: US 2006/0039038 A1
(43) Pub. Date: Feb. 23, 2006

(54) Multi-function peripheral outputting image data for multiple uses

(75) Inventors: Bo-Hsiang Wang, Taiping City (TW); Te-Chuan Hsieh, Kaohsiung City (TW)

Correspondence Address: BIRCH STEWART KOLASCH & BIRCH, PO BOX 747, FALLS CHURCH, VA, 22040-0747, US

(73) Assignee: AVISION INC.

(21) Appl. No.: 11/205,136

(22) Filed: Aug. 17, 2005

(30) Foreign Application Priority Data
Aug. 20, 2004 (TW) 093125295

(51) Int. Cl. G06F 3/12; G06F 15/00

(52) U.S. Cl. 358/451; 358/448; 358/1.15

(57) ABSTRACT

A multi-function peripheral which outputs image data for multiple uses includes a scanning unit, a memory, a processor, a plurality of output units and an operation interface. The scanning unit scans a to-be-scanned object and generates an image signal, which is temporarily stored in the memory. The processor processes the image signal into a plurality of different output signals. The output unit generates a plurality of output results according to the output signals, respectively. The operation interface is for selecting at least two of output options provided and initiates a scan process, so that the processor processes the image signal into at least two output signals corresponding to the at least two output options and at least two of the output units generate at least two output results corresponding to the at least two output signals.

### BACKGROUND OF THE INVENTION

1. Field of the Invention

The invention relates to a multi-function peripheral which outputs image data of an original for multiple uses, and more particularly to a multi-function peripheral capable of outputting multiple output results according to a scan result obtained by one scanning process.

2. Description of the Related Art

The conventional multi-function peripheral has the function of scanning a document and then independently performing the operation of printing, faxing through a phone line or a network, e-mail sending, electric file converting and filing, and the like. Thus, if a user wants to perform the operation of copying and faxing a document, for example, he or she has to place the document on the scanning unit, input the number of copies, and press the “copy” button, such that the scanning unit scans the document and then the scanned result is printed. Thereafter, the user has to place the document again (if an automatic document feeder is used), input the fax number, and then press the “fax” button, such that the scanning unit scans the document again and then the scanned result is faxed.

Thus, the scanning unit has to scan the document twice, and the user has to wait for the ending of the copying function and then perform the setting for the fax operation. Such a complicated operating procedure brings inconvenience for the user. In particularly, if three or four output functions have to be performed, the user may feel relatively inconvenient.

The current digital copier can copy the document into multiple copies by scanning the document only once. However, this digital copier cannot satisfy the user's needs because it can only provide the single copy function and cannot provide various output functions.

With the growing popularization of the function of digitizing the document, the multiple output functions mentioned hereinabove are the future trends of the multi-function peripherals. For example, when the user gets a document, he or she might need to copy the document into a copy to be preserved, to file and manage the electric file of the document, and to send the electric file to a remote user for reference through e-mail or fax. Thus, it is an important object of the invention to provide a multi-function peripheral with multiple output functions at a time.

### SUMMARY OF THE INVENTION

It is therefore an object of the invention to provide a multi-function peripheral which outputs image data for use in a faxing function, an e-mail sending function, a filing function, a storing function, a printing function, and the like, according to a scan result generated in one scan process.

To achieve the above-mentioned object, the invention provides a multi-function peripheral including a scanning unit, a memory, a processor, a plurality of output units and an operation interface. The scanning unit scans a to-be-scanned object and generates an image signal. The memory temporarily stores the image signal. The processor processes the image signal into a plurality of different output signals. The output units generate a plurality of different output results according to the output signals. The operation interface selects at least two of output options provided and initiates a scan process, so that the processor processes the image signal into at least two output signals corresponding to the at least two output options and at least two of the output units generate at least two output results corresponding to the at least two output signals.

The output units include at least two of: a printing unit for performing a printing operation; a faxing unit for performing a faxing operation; an e-mail sending unit for performing an e-mail sending operation; a filing unit for performing a filing operation; and a storing unit for performing a storing operation.

Thus, different output effects can be achieved after the scanning unit performs only a scanning process.

### BRIEF DESCRIPTION OF THE DRAWINGS

FIG. 1 is a block diagram showing a multi-function peripheral according to a preferred embodiment of the invention.

FIG. 2 shows one example of the operation interface of FIG. 1.

FIG. 3 shows another example of the operation interface of FIG. 1.

### DETAILED DESCRIPTION OF THE INVENTION

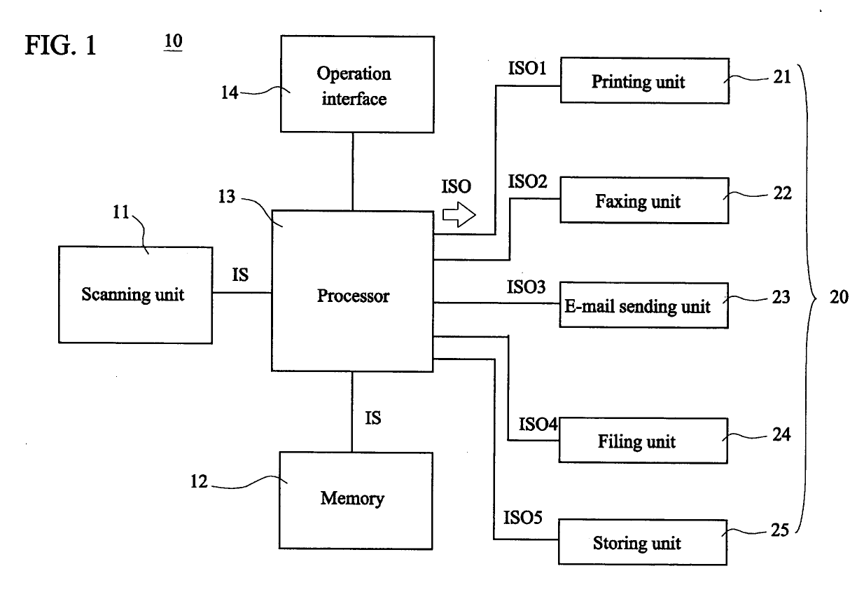

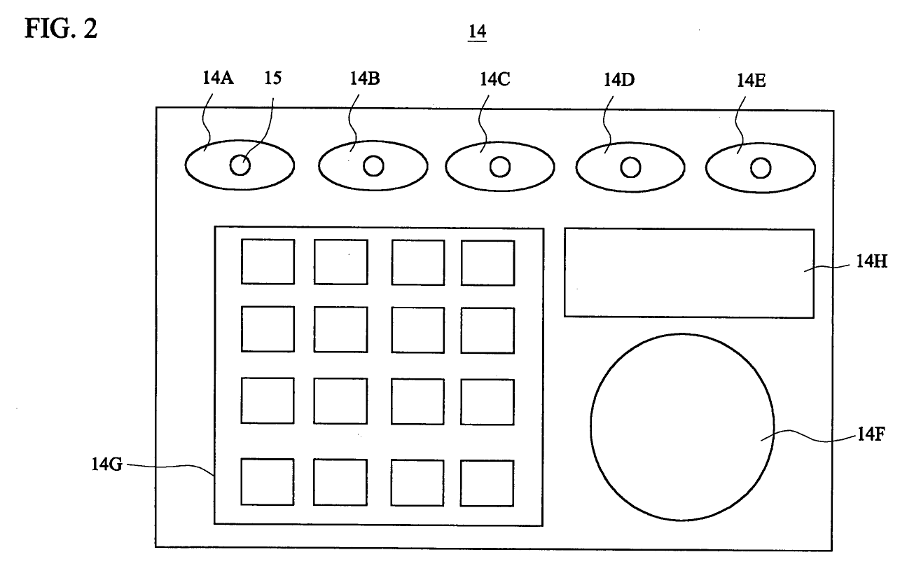

FIG. 1 is a block diagram showing a multi-function peripheral according to a preferred embodiment of the invention. FIG. 2 shows one example of the operation interface of FIG. 1. Referring to FIGS. 1 and 2, the multi-function peripheral 10 of this embodiment includes a scanning unit 11, a memory 12, a processor 13, a plurality of output units 20 and an operation interface 14.

The scanning unit 11 scans a to-be-scanned object and generates an image signal IS. The memory 12 temporarily stores the image signal IS. The processor 13 may process the image signal IS into a plurality of different output signals ISO (e.g., ISO1 to ISO5). The output units 20 generate a plurality of output results according to the output signals ISO, respectively.

In this embodiment, the output units 20 include a printing unit 21 for performing a printing operation, a faxing unit 22 for performing a faxing operation through a telephone line or a network in a wired or wireless manner, an e-mail sending unit 23 for performing an e-mail sending operation in a wired or wireless manner, a filing unit 24 for performing a filing operation in a wired or wireless manner, and a storing unit 25 for performing a storing operation in a wired or wireless manner. It is to be noted that only two of the above-mentioned units are allowed to implement this invention. The storing unit 25 may be a portable data storage device such that the user may carry the scanned data in the portable data storage device such as a thumb disk.

The operation interface 14 includes a plurality of function buttons 14A to 14E and a start button 14F. The button 14A corresponds to the output function of the printing unit 21. That is, the multi-function peripheral 10 is instructed to perform the copy operation if the button 14A is pressed. The button 14B corresponds to the output function of the faxing unit 22. That is, the multi-function peripheral 10 is instructed to perform the faxing operation if the button 14B is pressed. The button 14C corresponds to the output function of the e-mail sending unit 23. That is, the multi-function peripheral 10 is instructed to perform the e-mail operation if the button 14C is pressed. The button 14D corresponds to the output function of the filing unit 24. That is, the multi-function peripheral 10 is instructed to perform the filing operation if the button 14D is pressed. The button 14E corresponds to the output function of the storing unit 25. That is, the multi-function peripheral 10 is instructed to perform the storing operation if the button 14E is pressed. When the start button 14F is pressed, the operations corresponding to the function buttons 14A to 14E are performed according to the instructions. Each of the function buttons 14A to 14E has a state indicator 15 to indicate that one of the function buttons 14A to 14E have been pressed.

The operation interface 14 is configured such that a user can choose at least two of the output signals ISO to be outputted from at least two of the output units 20. Thus, the image signal IS generated by the scanning unit 11 in a single scan process may be outputted as the different output results. In other words, the user selects at least two of output options provided and initiates a scan process via the operation interface 14, so that the processor 13 processes the image signal IS into at least two output signals ISO corresponding to the at least two output options and at least two of the output units 20 generate at least two output results corresponding to the at least two output signals ISO. The operation interface 14 further includes a keyboard 14G and a display unit 14H. The keyboard 14G is operated to output operation information, and the display unit 14H displays the operation information.

In another embodiment, the display unit 14H may also be a touch panel with the display function and the button function.

In an actual operation state, for example, the user can press the function buttons 14A, 14C and 14E. At this time, the state indicators 15 respectively corresponding to each of the function buttons 14A, 14C and 14E indicate that the corresponding functions have been selected. At this time, the user can still change the functions to be executed. For example, he or she can reset the function buttons or press the function buttons again so as to cancel the functions corresponding to the function buttons. Then, he or she can input the essential information corresponding to the function buttons 14A, 14C and 14E through the display unit 14H and the keyboard 14G. For example, the essential information corresponding to the function button 14A may include the number of copies, the copy size, and the like. The essential information corresponding to the function button 14B may include the fax number and the like. The essential information corresponding to the function button 14C may include the e-mail address and the like. The essential information corresponding to the function button 14D may include the filing position and the like. The essential information corresponding to the function button 14E may include the identification of the to-be-stored storage device.

After the above-mentioned settings are finished, the user presses the start button 14F and the multi-function peripheral scans an original once by the scanning unit 11 and then performs the operations of printing, e-mail sending, and data storing. The user does not have to wait for the ending of the previous work and then set the setting for the next work. Thus, it is very convenient to use the multi-function peripheral without missing works. In the prior art, the user might pick up a phone after the first and second works are finished and then forget to perform the third work. Thus, the invention provides a convenient way to perform multiple output operations.

In another embodiment, after the output function is completed, the memory 12 can temporarily store the image signal IS for a predetermined period of time, such as 5 to 30 seconds. Alternatively, after the image signal IS is generated, the memory 12 temporarily stores the image signal IS for a predetermined period of time. When one of the output options is selected again within the predetermined period of time, the processor 13 processes the image signal IS into the output signal and outputs the output signal, such that the output unit corresponding to the output signal generates the output result according to the output signal. For example, the user can press the “fax” and “print” buttons at the beginning. After the faxing and copying functions are finished, he or she can press the “filing” button if the scan result has to be filed. In this case, the lighting indicators represent that functional instruction signals are successfully generated. That is, the scan results may be faxed, printed, and filed.

Alternatively, after the fax and copy functions are finished, the image signal can still be filed as long as the user presses the “filing” button within this predetermined of time. Then, the predetermined period of time may be reset and the waiting period is re-counted from the ending of the filing function so that the multi-function peripheral can wait for the generation of another functional instruction signal. If no functional instruction signal is generated, the image signal in the memory is cleared.

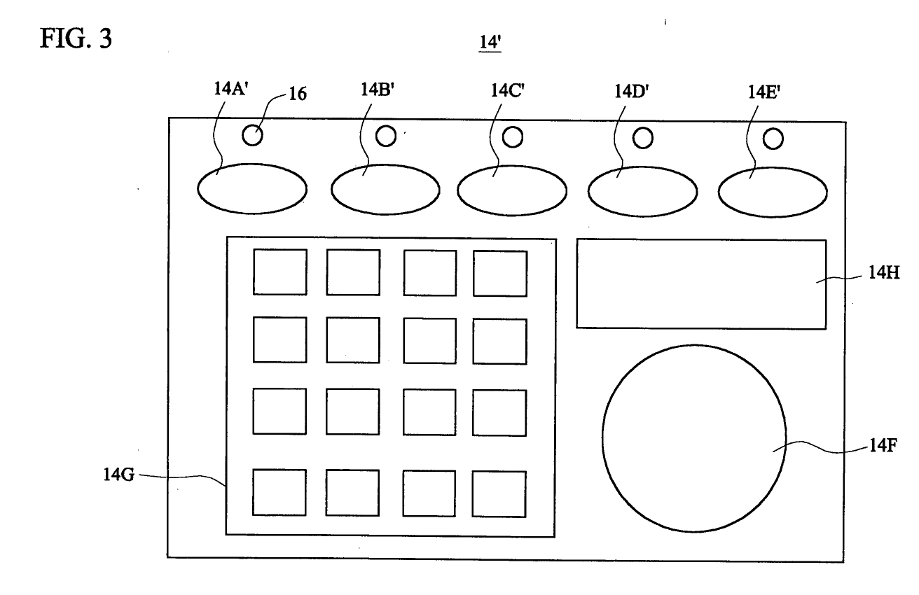

FIG. 3 shows another example of the operation interface of FIG. 1. As shown in FIG. 3, the operation interface 14′ is similar to that of FIG. 2 except that the operation interface 14′ further includes a plurality of state indicators 16 outside the function buttons 14A′ to 14E′. The state indicators 16 respectively corresponding to each of the function buttons 14A′ to 14E′ indicate that the corresponding buttons have been pressed. Thus, the embodiment can also provide a very convenient operation environment.

While the invention has been described by way of examples and in terms of preferred embodiments, it is to be understood that the invention is not limited to the disclosed embodiments. To the contrary, it is intended to cover various modifications. Therefore, the scope of the appended claims should be accorded the broadest interpretation so as to encompass all such modifications.

What is claimed is:

1. A multi-function peripheral, comprising:
a scanning unit for scanning a to-be-scanned object and generating an image signal;
a memory for temporarily storing the image signal;
a processor for processing the image signal into a plurality of different output signals;
a plurality of output units for generating a plurality of different output results according to the output signals; and
an operation interface for selecting at least two of output options provided and for initiating a scan process, so that the processor processes the image signal into at least two output signals corresponding to the at least two output options and at least two of the output units generate at least two output results corresponding to the at least two output signals.

2. The multi-function peripheral according to claim 1, wherein the output units comprise at least two of:
a printing unit for performing a printing operation;
a faxing unit for performing a faxing operation;
an e-mail sending unit for performing an e-mail sending operation;
a filing unit for performing a filing operation; and
a storing unit for performing a storing operation.

3. The multi-function peripheral according to claim 2, wherein the storing unit is a portable data storage device.

4. The multi-function peripheral according to claim 1, wherein the operation interface comprises a plurality of function buttons and a start button.

5. The multi-function peripheral according to claim 4, wherein each of the function buttons has a state indicator to indicate that one of the function buttons has been pressed.

6. The multi-function peripheral according to claim 4, wherein the operation interface further comprises a plurality of state indicators respectively corresponding to each of the function buttons, and the state indicators indicate that the corresponding function buttons have been pressed.

7. The multi-function peripheral according to claim 1, wherein the operation interface further comprises:
a keyboard operated to output operation information; and
a display unit for displaying the operation information.

8. The multi-function peripheral according to claim 1, wherein the display unit is a touch panel.

9. The multi-function peripheral according to claim 1, wherein the memory temporarily stores the image signal for a predetermined period of time.

10. The multi-function peripheral according to claim 9, wherein when one of the output options is selected again within the predetermined period of time, the processor processes the image signal into the output signal and outputs the output signal such that the output unit corresponding to the output signal generates the output result according to the output signal.

11. The multi-function peripheral according to claim 1, wherein the memory temporarily stores the image signal for a predetermined period of time after the at least two of the output signals have been outputted.

12. The multi-function peripheral according to claim 11, wherein when one of the output options is selected again within the predetermined period of time, the processor processes the image signal into the output signal and outputs the output signal such that the output unit corresponding to the output signal generates the output result according to the output signal.
